(19) United States
(12) Patent Application Publication
(10) Pub. No.: US 2019/0226437 A1
(43) Pub. Date: Jul. 25, 2019

(54) VALVE FOR METERING A FLUID, CONNECTION PIECE FOR A VALVE, AND FUEL INJECTION SYSTEM

(71) Applicant: Robert Bosch GmbH, Stuttgart (DE)

(72) Inventors: Guido Pilgram, Gundelsheim (DE); Ralf Kromer, Vaihingen (DE); Stefanie Capek, Stuttgart (DE); Thilo Beckmann, Litzendorf Naisa (DE)

(21) Appl. No.: 16/312,639

(22) PCT Filed: Jun. 21, 2017
(86) PCT No.: PCT/EP2017/065204

§ 371 Date: Mar. 21, 2019

(30) Foreign Application Priority Data
Jun. 30, 2016 (DE) 10 2016 211 835.8
Apr. 27, 2017 (DE) 10 2017 207 088.9

(51) Int. Cl. F02M 55/00; F02M 61/14; F16J 15/02

(52) U.S. Cl. CPC F02M 55/005; F02M 61/14; F02M 2200/9015; F02M 2200/856; F16J 15/022

(57) ABSTRACT

A connection piece for a valve, which is utilized for metering a fluid, includes a sealing section, on which at least one annular sealing element is situated. The annular sealing element circumferentially surrounds the sealing section with respect to a longitudinal axis. Furthermore, the annular sealing element is supported on an end of the sealing section with the aid of a support ring. The sealing section has a circumference increasing along the longitudinal axis at least in an area along the longitudinal axis in which the annular sealing element surrounds the sealing section.

### FIELD OF THE INVENTION

The present invention relates to a valve for metering a fluid, in particular, a fuel injection valve for internal combustion engines, a connection piece for such a valve, and a fuel injection system including such a valve. Specifically, the present invention relates to the field of fuel injection systems of motor vehicles, in which a direct injection of fuel into combustion chambers of an internal combustion engine may take place with the aid of multiple injectors.

### BACKGROUND INFORMATION

Patent document US 2011/0000464 A1 discusses an injector mounting assembly, in which a sealing ring is situated on a connection fitting, which is supported, via a support ring, on a shoulder of the connection fitting. The connection fitting is inserted, in the area of its sealing ring, into a cup, whereby the sealing ring seals the interior space of the cup with respect to the surroundings, in order to guide fuel into the connection fitting of the injector.

The injector mounting assembly from US 2011/0000464 A1 has the disadvantage that a degraded sealing effect may occur, in particular, over the service life of the injector.

### SUMMARY OF THE INVENTION

The connection piece according to the present invention having the features described herein, the valve according to the present invention having the features described herein, and the fuel injection system according to the present invention having the features described herein have the advantage that an improved configuration and mode of operation are made possible. In particular, an improved sealing effect may be achieved. Specifically, an improved area of application may be implemented, which relates, for example, to the range of use and/or the service life.

Depending on the configuration of the sealing element, a limitation of the seal tightness may result not only over the service life, but also, for example, with respect to the temperature range which is relevant for the application. Advantageously, due to the provided configuration of the sealing section, an improved sealing function may be achieved, with the aid of which an improved sealing effect may also be achieved at low temperatures. Therefore, the provided configuration may support the sealing function.

The refinement as described herein has the advantage that the sealing element may already be clamped or preloaded between the sealing section and the cup during insertion. Therefore, a reliable sealing effect may already be achieved during introduction of the fuel, without the sealing element being initially subjected to a position change due to the rising fuel pressure.

In the refinement as described herein, an axially symmetric configuration of the sealing section, on its outer side, with respect to the longitudinal axis may be advantageously achieved. Moreover, it is advantageous, in this case, that the sealing section is configured having an outer diameter increasing along the longitudinal axis, at least in the area counter to the joining direction, in which an insertion along the longitudinal axis into a cup takes place.

Particularly good effectiveness has been demonstrated specifically for the refinement as described herein. Specifically, a very good sealing behavior in the case of this configuration has been demonstrated in laboratory experiments at low temperatures and with the aid of simulations. The conical contour of the connection piece had the effect, in this case, that the medium utilized as fluid did not flow around a sealing ring utilized as a sealing element. Specifically, with the aid of a simulation, it has been shown, in this case, that a principle-related increase of the contact pressure and, therefore, of the sealing effect takes place due to the conical configuration. Therefore, an enhanced sealing effect may be achieved specifically in the range of low temperatures. This is not the case with a cylinder shell-shaped configuration of the connection piece in the area in which the sealing element interacts with the connection piece in order to create the sealing effect.

In the refinement as described herein, the configuration of the support ring as a gapless circumferential support ring is particularly advantageous from a geometric perspective. The support ring may also be configured as a slotted support ring, in particular, as a slotted support disk, however, in order to facilitate installation. The support ring may advantageously support the sealing element toward the side facing away from the pressure. When acted upon by the system pressure, the sealing element is also pressed against the support ring and is elastically deformed.

In the refinement described herein, the support ring may include, for example, a conical support surface, in particular, when the sealing section is configured to be conical in this area, whereby the support ring is also positioned in a defined manner with respect to the longitudinal axis. Due to the position of the support ring, the end of the sealing section may also be predefined in this way. The support ring may be formed from a temperature-resistant material. The support ring may be formed from a polyamide. The support ring may be configured not to be slotted, but rather annularly closed. In this case, the support ring may be configured in such a way that it shifts axially on the conical sealing section and thereby expands at least as a result of the pressures prevailing during operation. The configuration may be tailored in such a way, in this case, that the support ring expands until it also rests outwardly against the cup. As a result, due to the support ring, a secondary seal may also be formed between the sealing section and an inner surface of the receiving piece, in particular, an inner surface of the cup, which supplements the sealing effect imparted via the sealing ring.

In a modified configuration, the support ring may include a conical support surface when the sealing section is configured to be conical in this area and the support ring is pressed onto the sealing section, with respect to the longitudinal axis, and is then appropriately positioned. Depending on the configuration, the end of the sealing section may then be predefined by the resultant position of the sealing ring or of the support ring.

Advantageous configurations of the sealing element are described herein. A configuration of the sealing element, in particular, which corresponds to an O-ring having a cross section which is circular in the relaxed initial state may be advantageous in this case.

The configuration as described herein has the advantage that a self-reinforcing sealing effect of the sealing element may be achieved, since the pressing of the sealing element inwardly toward the sealing section and, simultaneously, outwardly toward the cylinder shell-shaped inner surface of the receiving piece is reinforced by the fuel pressure. This applies, in particular and, if necessary, also only with respect to a dynamic pressure load (for example, of approximately 0 bar to more than 300 bar in 0.67 s) and/or at low temperatures (for example, of −40° C.), also, for example, below a so-called TR10 value of an elastomer, when an appropriate configuration has been implemented.

Exemplary embodiments of the present invention are explained in greater detail in the following description with reference to the attached drawings, in which identical elements are provided with identical reference numerals.

### BRIEF DESCRIPTION OF THE DRAWINGS

FIG. 1 shows a fuel injection system including a valve which includes a connection piece in extracts of a schematic sectional representation according to an exemplary embodiment of the present invention.

FIG. 2 shows in extracts of a representation of a sealing element and of a support ring of the valve represented in FIG. 1, in a profile view.

### DETAILED DESCRIPTION

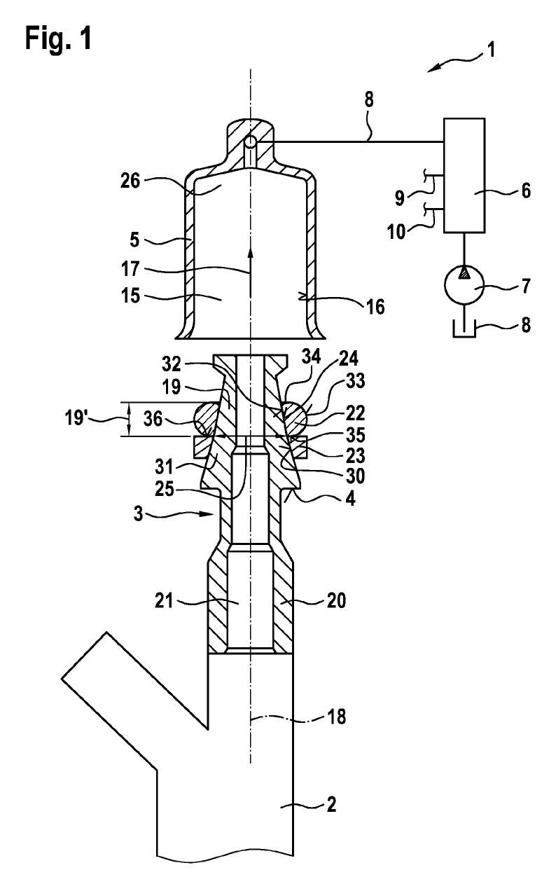

FIG. 1 shows a fuel injection system 1 including a valve 2 which includes a connection piece 3, in extracts of a schematic sectional representation according to one exemplary embodiment. Valve 2 may be configured, in particular, as a fuel injection valve 2. An application is a fuel injection system 1, in which such fuel injection valves 2 are configured as high-pressure injection valves 2 and are utilized for the direct injection of fuel into assigned combustion chambers of the internal combustion engine. Liquid or gaseous fuels may be utilized as fuel in this case.

Connection piece 3 is configured as a connection fitting 3 in this exemplary embodiment and is integrated into valve 2 in a suitable way. Connection piece 3 includes a shoulder 4, on which a mounting bracket or the like may engage, for example, in the assembled state, in order to connect valve 2 to a receiving piece 5. Receiving piece 5 is configured as a cup 5 in this exemplary embodiment.

Fuel injection system 1 includes a fuel-conveying component 6 which is configured as a fuel distributor 6, in particular, as a fuel rail 6, in this exemplary embodiment. Cup 5 may be part of fuel-conveying component 6 in this case.

During operation, fuel is conveyed from a tank 8 into fuel distributor 6 via one or multiple pumps 7. Fuel distributor 6 then distributes the fuel to fuel injection valves 2 which are connected to corresponding cups 5. In this exemplary embodiment, only fuel injection valve 2 and cup 5 are represented, for the sake of simplicity of the representation. The distribution of the fuel is schematically illustrated in this case via lines 8, 9, and 10.

Cup 5 includes an at least partially cylindrical receiving space 15 which includes a cylinder shell-shaped inner surface 16 at least in one portion. For the purpose of installation, fuel injection valve 2 is inserted into cup 5 in a joining direction 17 along a longitudinal axis 18. As a result, a sealing section 19 of connection piece 3, viewed along longitudinal axis 18, enters cylinder shell-shaped inner surface 16 along longitudinal axis 18.

Connection piece 3 includes a tubular, metallic base body 20 including a through-hole 21 which is configured as a stepped hole 21 in this exemplary embodiment. Moreover, connection piece 3 includes a sealing element 22, which is configured as a sealing ring 22, and a support ring 23. Support ring 23 may be configured as a circumferentially closed support ring 23.

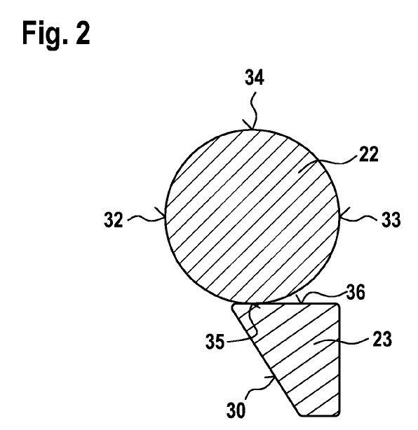

Sealing element 22 is configured as an O-ring. A profile of sealing element 22 in the relaxed state may be configured to be circular, as illustrated in FIG. 2.

Sealing section 19 is formed on base body 20 and extends across an area 19′. In area 19′, sealing section 19 includes a conical lateral surface 24. Conical lateral surface 24 is the lateral surface 24 of a truncated cone in this case. Conical lateral surface 24 tapers in joining direction 17 in this case. This means, conical lateral surface 24 expands counter to joining direction 17. Therefore, in this exemplary embodiment, sealing section 19 has an outer diameter 25 increasing along longitudinal axis 18 counter to joining direction 17. As outer diameter 25 increases, a circumference on sealing element 22 also increases along longitudinal axis 18. In this exemplary embodiment, the circumference results from the circle having outer diameter 25 which increases in sealing section 19 counter to joining direction 17.

Therefore, sealing section 19 of base body 20 of connection piece 3 is configured having a circumference increasing along longitudinal axis 18 in area 19′ along longitudinal axis 18, in which annular sealing element 22 surrounds sealing section 19.

Sealing element 22 is pressed against support ring 23 upon insertion of connection piece 3 into cup 5. As a result, sealing element 22 is positioned after insertion into cup 5. Moreover, an elastic deformation of sealing element 22 on conical lateral surface 24 takes place. As a result, sealing element 22 is also pressed against cylinder shell-shaped inner surface 16 of cup 5. When fuel is subsequently conveyed via line 8 into an interior space 26 of cup 5, sealing element 22 is acted upon by the pressure of the fuel. A further deformation of sealing element 22 may result. A sealing effect results, which is self-reinforcing due to the pressure.

In this exemplary embodiment, support ring 23 includes a support surface 30 resting against sealing section 19. Support surface 30 is likewise configured to be conical in this case, where the same opening angle may be predefined as for conical lateral surface 24. In this way, an end 31 for sealing section 19 along longitudinal axis 18 is predefined by support ring 23. Sealing element 22 is then supported on end 31 of sealing section 19 with the aid of support ring 23.

FIG. 2 shows in extracts a representation of sealing element 22 and of support ring 23 of valve 2 of fuel injection system 1 of the exemplary embodiment, which is represented in FIG. 1, in a profile view. In this case, sealing element 22 is represented in the initial state, i.e., without elastic deformation. Sealing element 22 has a circular profile in this case. During installation, sealing element 22 is deformed on an inner side 32 by sealing section 19 of base body 20. Moreover, sealing element 22 is pressed, on an outer side 33, against cylinder shell-shaped inner surface 16 of cup 5. Therefore, sealing element 22 is also deformed in the area of outer side 33.

During operation, sealing element 22 is acted upon by the pressure of the fuel on a fuel side 34 facing interior space 26 filled with fuel. In this case, sealing element 22 is supported, via its support side 35, on a support surface 36 of support ring 23. Support surface 36 may be oriented perpendicularly to longitudinal axis 18 in this case.

The present invention is not limited to the described exemplary embodiment.

1-10. (canceled)

11. A connection piece for a valve for metering a fluid, in particular, for a fuel injection valve of an internal combustion engine, comprising:
a sealing section, on which at least one annular sealing element is situated, the annular sealing element circumferentially surrounding the sealing section with respect to a longitudinal axis and the annular sealing element being at least indirectly supported on an end of the sealing section;
wherein the sealing section has a circumference increasing along the longitudinal axis at least in an area along the longitudinal axis in which the annular sealing element surrounds the sealing section.

12. The connection piece of claim 11, wherein the sealing section has a circumference increasing along the longitudinal axis, at least in the area counter to a joining direction, in which an insertion along the longitudinal axis into a cup takes place.

13. The connection piece of claim 11, wherein the sealing section has an outer diameter increasing along the longitudinal axis at least in the area.

14. The connection piece of claim 11, wherein the sealing section has a conical lateral surface at least in the area.

15. The connection piece of claim 11, wherein at least one support ring is situated on the sealing section, the support ring at least partially circumferentially surrounds the sealing section with respect to the longitudinal axis, and the sealing element is supported, with the aid of the support ring, on the end of the sealing section predefined by the support ring at least during operation.

16. The connection piece of claim 15, wherein the support ring includes a support surface resting against the sealing element.

17. The connection piece of claim 11, wherein the sealing element has an elastically deformable sealing element and/or the sealing element is in the shape of an O-ring.

18. A valve for metering a fluid, comprising:
a connection piece via which the fluid is feedable;
wherein the connection piece includes:
a sealing section, on which at least one annular sealing element is situated, the annular sealing element circumferentially surrounding the sealing section with respect to a longitudinal axis and the annular sealing element being at least indirectly supported on an end of the sealing section;
wherein the sealing section has a circumference increasing along the longitudinal axis at least in an area along the longitudinal axis in which the annular sealing element surrounds the sealing section.

19. A fuel injection system for a mixture-compressing, spark-ignition internal combustion engine, comprising:
at least one fuel-conveying component having a receiving piece; and
at least one valve configured as a fuel injection valve, the connection piece of the valve being insertable along the longitudinal axis into the receiving piece;
wherein the valve includes:
a connection piece via which the fluid is feedable;
wherein the connection piece includes:
a sealing section, on which at least one annular sealing element is situated, the annular sealing element circumferentially surrounding the sealing section with respect to a longitudinal axis and the annular sealing element being at least indirectly supported on an end of the sealing section;
wherein the sealing section has a circumference increasing along the longitudinal axis at least in an area along the longitudinal axis in which the annular sealing element surrounds the sealing section.

20. The fuel injection system of claim 19, wherein the receiving piece includes an at least partially cylindrical receiving space, the sealing element, in the installed state, rests outwardly against a cylinder shell-shaped inner surface of the receiving piece and inwardly against the sealing section, and the sealing element is acted upon, during operation, by a fuel pressure along the longitudinal axis in the direction counter to the increasing circumference of the sealing section.

21. The connection piece of claim 11, wherein the valve is a fuel injection valve of an internal combustion engine.

22. The valve of claim 18, wherein the valve is a fuel injection valve of an internal combustion engine.
